(19) United States
(12) Patent Application Publication
(10) Pub. No.: US 2007/0132394 A1
(43) Pub. Date: Jun. 14, 2007

(54) Display device

(76) Inventors: Hyoung-Bin Park, Suwon-si (KR); Seung-Hyun Son, Suwon-si (KR); Sang-Hun Jang, Suwon-si (KR); Gi-Yoong Kim, Suwon-si (KR); Sung-Soo Kim, Suwon-si (KR); Xiaoqing Zeng, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/636,289

(22) Filed: Dec. 8, 2006

(30) Foreign Application Priority Data
Dec. 12, 2005 (KR) 10-2005-0121941

(51) Int. Cl. H01J 17/49

(52) U.S. Cl. 313/587; 313/582

(57) ABSTRACT

Provided is a display device. The display device includes: a first substrate and a second substrate facing each other with a plurality of discharge cells therebetween; a plurality of first electrodes formed on an inner surface of the first substrate; a plurality of electron emission sources disposed on the inner side of the first substrate to correspond to the first electrodes, and emitting electrons into the discharge cells; a discharge gas filled in the discharge cells; light emitting layers formed on inner walls of the discharge cells; and protective layers covering the light emitting layers, and formed of materials through which excitation sources for exciting the light emitting layers can be transmitted.

### CROSS-REFERENCE TO RELATED PATENT APPLICATIONS

This application claims the benefit of Korean Patent Application No. 10-2005-0121941, filed on Dec. 12, 2005, in the Korean Intellectual Property Office, the disclosure of which is incorporated herein in its entirety by reference.

### BACKGROUND OF THE INVENTION

1. Field of the Invention

The present embodiments relate to a display device, and more particularly, to a display device that can improve luminous efficiency and reduce a driving voltage.

2. Description of the Related Art

Plasma display panels (PDPs) are display devices which display an image using an electrical discharge. PDPs have become popular due to their characteristics of high brightness and wide viewing angle. In PDPs, a gas discharge is generated between electrodes by voltages applied to the electrodes, and then visible light is emitted from a phosphor layer that is excited by ultraviolet (UV) rays created when the gas discharge is generated.

PDPs can be categorized into a direct current (DC) type and an alternating current (AC) type according to a discharge mechanism. In DC PDPs, all electrodes are exposed to a discharge space and electric charges move directly between corresponding electrodes. In AC PDPs, at least one electrode is covered by a dielectric layer, and a discharge is generated by wall charges, not by the migration of electric charges between corresponding electrodes.

PDPs can also be categorized into a facing discharge type and a surface discharge type according to the arrangement of electrodes. In facing discharge PDPs, a pair of sustain electrodes are respectively disposed on an upper substrate and a lower substrate, and a discharge occurs in a direction perpendicular to the substrates. In surface discharge PDPs, a pair of sustain electrodes are disposed on the same substrate, and a discharge occurs in a direction parallel to the substrate.

The facing discharge PDPs have high luminous efficiency, but have a drawback in that a phosphor layer is easily deteriorated by plasma. Therefore, the surface discharge PDPs are mainly used.

FIG. 1 is an exploded perspective of a conventional surface discharge PDP. FIGS. 2A and 2B are respectively a horizontal sectional view and a vertical sectional view of the conventional surface discharge PDP of FIG. 1.

Referring to FIGS. 1, 2A, and 2B, the conventional PDP includes an upper substrate 20 and a lower substrate 10 which are spaced from each other by a discharge space in which a plasma discharge occurs.

A plurality of address electrodes 11 are arranged in stripes on a top surface of the lower substrate 10, and are covered by a first dielectric layer 12. A plurality of barrier ribs 13, which divide the discharge space to define a plurality of discharge cells 14 and prevent electrical and optical cross-talk between the discharge cells 14, are formed at predetermined intervals on a top surface of the first dielectric layer 12. Red (R), green (G), and blue (B) phosphor layers 15 are coated on inner walls of the discharge cells 14 to a predetermined thickness. A discharge gas is filled in the discharge cells 14.

The upper substrate 20 is a transparent substrate generally formed of glass through which visible light can be transmitted, and is coupled to the lower substrate 10 on which the barrier ribs 13 are formed. Stripe-shaped sustain electrodes 21a and 21b are arranged in pairs on a bottom surface of the upper substrate 20 to perpendicularly intersect the address electrodes 11. The sustain electrodes 21a and 21b are formed of transparent conductive materials, such as Indium Tin Oxide (ITO), through which visible light can be transmitted. In order to reduce the line resistance of the sustain electrodes 21a and 21b, bus electrodes 22a and 22b having smaller widths than those of the sustain electrodes 21a and 21b are formed on bottom surfaces of the sustain electrodes 21a and 21b. The sustain electrodes 21a and 21b and the bus electrodes 22a and 22b are covered by a transparent second dielectric layer 23. A protective layer 24 made of magnesium oxide (MgO) is formed on a bottom surface of the second dielectric layer 23.

In the conventional PDP constructed as above, the protective layer 24 prevents the second dielectric layer 23 from being damaged by sputtering of plasma particles, and reduces a driving voltage by emitting secondary electrons. However, since the protective layer 24 formed of MgO has a low secondary electron emission coefficient, there is a limitation in sufficiently emitting electrons into the discharge space. Also, since the protective layer 24 formed of MgO cannot transmit UV rays that excite the phosphor layers 15, the phosphor layers 15 cannot be formed between the upper substrate 20 and the protective layer 24.

Furthermore, in a conventional PDP, a plasma discharge occurs when the discharge gas containing xenon (Xe) is ionized and then drops from its excited state, thereby emitting UV rays. Accordingly, in order to form an image, the conventional PDP requires energy high enough to ionize the discharge gas, and thus has the disadvantages of a high driving voltage and low luminous efficiency.

### SUMMARY OF THE INVENTION

The present embodiments provide a display device that can improve luminous efficiency and reduce a discharge voltage.

According to an aspect of the present embodiments, there is provided a display device comprising: a first substrate and a second substrate facing each other with a plurality of discharge cells therebetween; a plurality of first electrodes formed on an inner surface of the first substrate; a plurality of electron emission sources disposed on the inner side of the first substrate to correspond to the first electrodes, and emitting electrons into the discharge cells; a discharge gas filled in the discharge cells; light emitting layers formed on inner walls of the discharge cells; and protective layers covering the light emitting layers, and formed of materials through which excitation sources for exciting the light emitting layers can be transmitted.

The protective layers may be formed of materials including magnesium fluoride (MgF₂).

The electron emission sources may be parallel to the first electrodes. The electron emission sources may be formed of one selected from the group consisting of oxidized porous silicon, carbon nanotube (CNT), diamond like carbon (DLC), and nanowire. The oxidized porous silicon may be oxidized porous polysilicon or oxidized porous amorphous silicon.

The display device may further comprise a first dielectric layer formed between the first substrate and the electron emission sources to cover the first electrodes. The light emitting layers may be formed on the first dielectric layer, and the protective layers may cover the light emitting layers. The display device may further comprise base electrodes formed between the first dielectric layer and the electron emission sources.

The display device may further comprise a plurality of second electrodes formed on an inner surface of the second substrate. The display device may further comprise a second dielectric layer formed on the inner surface of the second substrate to cover the second electrodes, wherein the light emitting layers are formed on the second dielectric layer, and the protective layers cover the light emitting layers.

The first electrodes may include pairs of sustain electrodes arranged in parallel, and the second electrodes may include address electrodes intersecting the sustain electrodes.

According to another aspect of the present embodiments, there is provided a display device comprising: a first substrate and a second substrate facing each other with a plurality of discharge cells therebetween; a plurality of first electrodes formed on an inner surface of the first substrate; a first dielectric layer formed on the inner surface of the first substrate to expose surfaces of the first electrodes; a plurality of electron emission sources disposed on the exposed surfaces of the first electrodes and emitting electrons into the discharge cells; a discharge gas filled in the discharge cells; light emitting layers formed on inner walls of the discharge cells; and protective layers covering the light emitting layers, and formed of materials through which excitation sources for exciting the light emitting layers can be transmitted.

According to still another aspect of the present embodiments, there is provided a display device comprising: a first substrate and a second substrate facing each other with a plurality of light emitting cells therebetween; an excitation gas filled in the light emitting cells; light emitting layers formed on inner walls of the light emitting cells; a plurality of electron emitting means disposed on an inner side of at least one of the first substrate and the second substrate, and emitting electrons for exciting the excitation gas into the light emitting cells; and protective layers covering the light emitting layers, and formed of materials through which excitation sources for exciting the light emitting layers can be transmitted.

The electrons emitted by the electron emitting means may have energy greater than energy required to excite the excitation gas and less than energy required to ionize the excitation gas.

Each of the electron emitting means may comprise: a first electrode formed on the inner surface of the at least one substrate; a second electrode spaced apart from the first electrode with their surfaces facing each other; and an electron acceleration layer disposed between the first electrode and the second electrode, and accelerating and emitting electrons into each of the light emitting cells when voltages are applied to the first electrode and the second electrode.

The display device may further comprise third electrodes formed on an inner surface of the remaining one of the first substrate and the second substrate where the electron emitting means are not disposed. When voltages respectively applied to the first electrodes, the second electrodes, and the third electrodes are V₁, V₂, and V₃, V₁<V₂<V₃ or V₁<V₂=V₃ may be satisfied.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel (PDP);

FIGS. 2A and 2B are respectively a horizontal sectional view and a vertical sectional view of the conventional PDP of FIG. 1;

FIG. 3 is a sectional view of a display device according to an embodiment;

FIG. 4 is a sectional view of a display device according to another embodiment;

FIG. 5 is a sectional view of a display device according to still another embodiment; and

FIG. 6 is a graph illustrating energy levels of xenon (Xe).

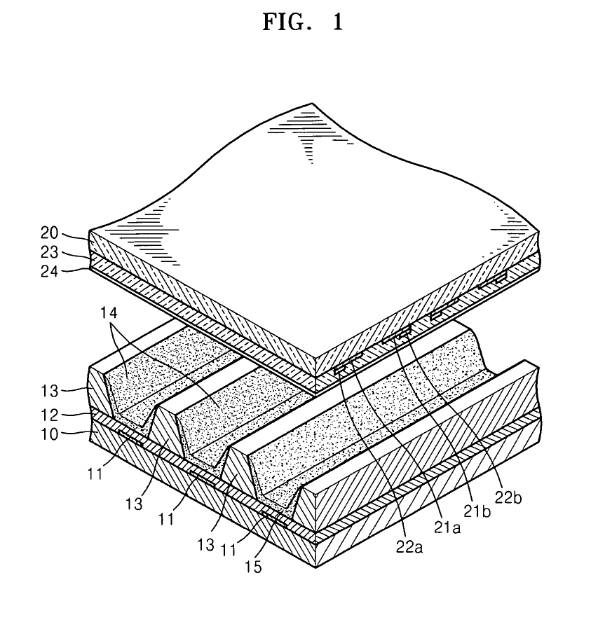

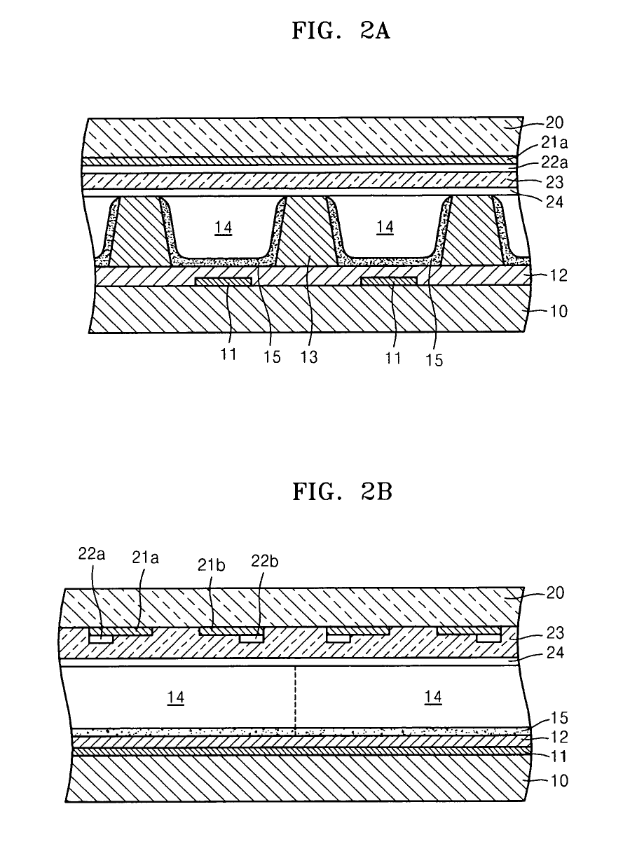

### DETAILED DESCRIPTION OF THE INVENTION

The present embodiments will now be described more fully with reference to the accompanying drawings, in which exemplary embodiments are shown. Like reference numerals denote like elements in the drawings.

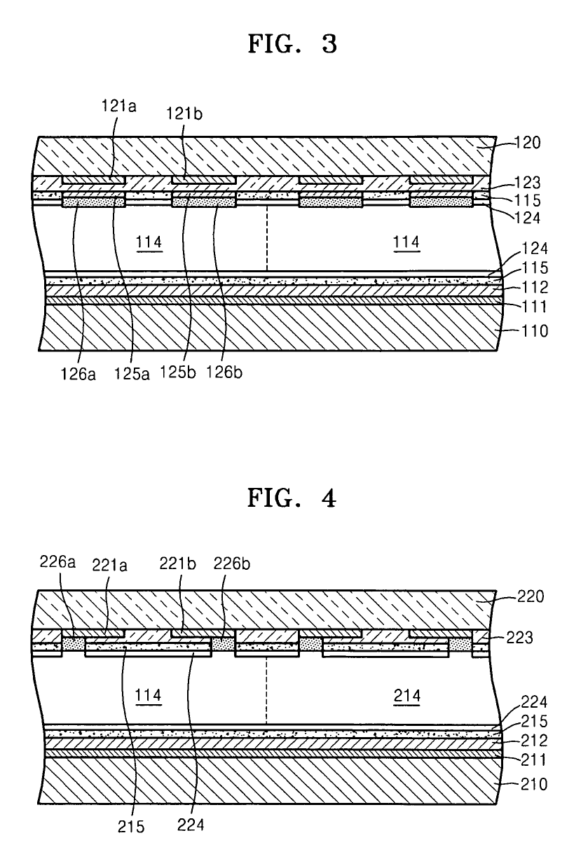

FIG. 3 is a partial sectional view of a display device, e.g., a plasma display panel (PDP), according to an embodiment.

Referring to FIG. 3, an upper substrate 120, which is a first substrate, and a lower substrate 110, which is a second substrate, are spaced apart from each other with their surfaces facing each other. A plurality of discharge cells 114 where a plasma discharge occurs are formed between the upper substrate 120 and the lower substrate 110. Although not shown in FIG. 3, a plurality of barrier ribs, which divide a space between the upper substrate 120 and the lower substrate 110 to define the discharge cells 114 and prevent electrical and optical cross-talk between the discharge cells 114, are formed between the upper substrate 120 and the lower substrate 110.

The upper substrate 120 can be, for example, a glass substrate through which visible light can be transmitted. A plurality of first electrodes is formed on a bottom surface of the upper substrate 120 to correspond to the discharge cells 114. The first electrodes include pairs of first and second sustain electrodes 121a and 121b which are arranged in parallel. The first and second sustain electrodes 121a and 121b may be formed of transparent conductive materials such as Indium Tin Oxide (ITO). In order to reduce the line resistance of the first and second sustain electrodes 121a and 121b, bus electrodes (not shown) may be formed on bottom surfaces of the first and second sustain electrodes 121a and 121b. The bus electrodes with smaller widths than those of the first and second sustain electrodes 121a and 121b may be formed along edges of the first and second sustain electrodes 121a and 121b. The bus electrodes may be formed of a metal with high electrical conductivity such as, for example, aluminium (Al) or silver (Ag).

A first dielectric layer 123 is formed on the bottom surface of the upper substrate 120 to a predetermined thickness to cover the first and second sustain electrodes 121a and 121b. First and second electron emission sources 126a and 126b are formed on a bottom surface of the first dielectric layer 123 to correspond to the first and second sustain electrodes 121a and 121b. The first and second electron emission sources 126a and 126b are parallel to the first and second sustain electrodes 121a and 121b. First and second base electrodes 125a and 125b may be respectively formed between the first dielectric layer 123 and the first electron emission sources 126 and between the first dielectric layer 123 and the second electron emission sources 126b. The first and second base electrodes 125a and 126b may be formed of ITO, Al, or Ag, for example.

As predetermined voltages are applied to the first and second sustain electrodes 121a and 121b, the first and second electron emission sources 126a and 126b accelerate and emit electrons into the discharge cells 114, thereby reducing a driving voltage. The first and second electron emission sources 126a and 126b may be formed of, for example, oxidized porous silicon, carbon nanotube (CNT), diamond like carbon (DLC), or nanowire. The oxidized porous silicon can be oxidized porous polysilicon or oxidized porous amorphous silicon.

The lower substrate 110 is generally a glass substrate, but the present embodiments are not limited thereto. A plurality of second electrodes is formed on a top surface of the lower substrate 110. The second electrodes include address electrodes 111 intersecting the first and second sustain electrodes 121a and 121b. A second dielectric layer 112 is formed on the top surface of the lower substrate 110 to cover the address electrodes 111.

A discharge gas that can generate ultraviolet (UV) rays during a discharge is filled in the discharge cells 114. The discharge gas may include, for example, xenon (Xe), nitrogen (N₂), deuterium (D₂), carbon dioxide (CO₂), hydrogen (H₂), carbon monoxide (CO), neon (Ne), helium (He), or argon (Ar). Light emitting layers 115 are coated on inner walls of the discharge cells 114, for example, on a bottom surface of the first dielectric layer 123, a top surface of the second dielectric layer 112, and side walls of the barrier ribs (not shown) to a predetermined thickness. The light emitting layers 115 may be coated to a thickness of about 20 μm or less. The light emitting layers 115 are generally formed of photo-luminescent materials that generate visible light by being excited by UV rays generated by a discharge. The light emitting layers 115 may further include cathode-luminescent materials that generate visible light by being excited by electrons, or materials including quantum dots.

Protective layers 124 can be formed on surfaces of the light emitting layers 115 to a predetermined thickness to prevent deterioration of the light emitting layers 115. The protective layers 124 may be formed to a thickness of about 1 μm or less. In the present embodiment, the protective layers 124 are formed of materials through which excitation sources for exciting the light emitting layers 115 can be transmitted. The protective layers 124 may be formed of, for example, materials including magnesium fluoride (MgF₂). The excitation sources of the light emitting layers 115 are generally UV rays generated during a discharge, and may include electrons emitted from the first and second electron emission sources 126a and 126b.

In the PDP constructed as above, if voltages of, for example, 1000 V and 0 V are respectively applied to the first and second sustain electrodes 121a and 121b to cause a discharge, electric fields directed from the first sustain electrodes 121a toward the second sustain electrodes 121b are formed in the discharge cells 114. Due to the electric fields, electrons are introduced from the second base electrodes 125b into the second electron emission sources 126b, accelerated by the second electron emission sources 126b, and then emitted into the discharge cells 114. Next, if voltages of, for example, 0 V and 1000 V are respectively applied to the first and second sustain electrodes 121a and 121b, accelerated electrons are emitted from the first electron emission sources 126a. In this regard, the PDP of the present embodiment can reduce a driving voltage and improve brightness and luminous efficiency because the first and second electron emission sources 126a and 126b emit the accelerated electrons into the discharge cells 114.

As conventional PDPs require a protective layer formed of a material with a high secondary electron emission coefficient and a high resistance against ion bombardment, the protective layer was formed of magnesium oxide (MgO) through which excitation sources of light emitting layers cannot be transmitted. However, according to the present embodiment, since many electrons are emitted by the first and second electron emission sources 126a and 126b into the discharge cells 114 and a discharge can occur at a sufficiently low voltage, the protective layers 124 may be formed of materials through which the excitation sources of the light emitting layers 115 can be transmitted. As a result, since the light emitting layers 115, some of which cannot be coated by the protective layer of the conventional PDPs, can be coated, the area of the coated light emitting layers 115 can be increased, thereby further improving brightness and luminous efficiency.

FIG. 4 is a partial sectional view of a display device, e.g., a PDP, according to another embodiment. An explanation will be made focusing on differences from the embodiment of FIG. 3.

Referring to FIG. 4, an upper substrate 220, which is a first substrate, and a lower substrate 210, which is a second substrate, are spaced apart from each other with their surfaces facing each other. A plurality of discharge cells 214 are formed between the upper substrate 220 and the lower substrate 210. A plurality of first electrodes is formed on a bottom surface of the upper substrate 220 to correspond to the discharge cells 214. The first electrodes include pairs of first and second sustain electrodes 221a and 221b which are arranged in parallel. First and second electron emission sources 226a and 226b are formed on bottom surfaces of the first and second sustain electrodes 221a and 221b, respectively. The first and second electron emission sources 226a and 226b may have widths less than those of the first and second sustain electrodes 221a and 221b. Bus electrodes (not shown) may be respectively formed between the first sustain electrodes 221a and the first electrode emission sources 226a and between the second sustain electrodes 221b and the second electron emission sources 226b to reduce the line resistance of the first and second sustain electrodes 221a and 221b.

As predetermined voltages are applied to the first and second sustain electrodes 221a and 221b, the first and second electron emission sources 226a and 226b accelerate and emit electrons into the discharge cells 214 to improve electron emission efficiency as described above. The first and second electron emission sources 226a and 226b may be formed of, for example, oxidized porous silicon, CNT, DLT, or nanowire. The oxidized porous silicon can be oxidized porous polysilicon or oxidized porous amorphous silicon. A first dielectric layer 223 is formed on a bottom surface of the upper substrate 220 to a predetermined thickness to expose bottom surfaces of the first and second electron emission sources 226a and 226b.

A plurality of second electrodes are formed on a top surface of the lower substrate 210. The second electrodes include address electrodes 211 intersecting the first and second sustain electrodes 221a and 221b. A second dielectric layer 212 is formed on the top surface of the lower substrate 210 to cover the address electrodes 211.

A discharge gas for generating UV rays during a discharge is filled in the discharge cells 214. Light emitting layers 215 are respectively formed to a predetermined thickness on inner walls of the discharge cells 214, for example, on a bottom surface of the first dielectric layer 223, a top surface of the second dielectric layer 212, and side walls of barrier ribs (not shown). Protective layers 224 are formed on surfaces of the light emitting layers 215 to a predetermined thickness. The protective layers 224 can include materials through which excitation sources for exciting the light emitting layers 215 can be transmitted. The protective layers 224 may be formed of, for example, materials including MgF₂.

Although the electron emission sources that can improve electron emission characteristics and the protective layers that are formed of materials through which the excitation sources of the phosphor layers can be transmitted are applied to the surface discharge PDPs in the above embodiments, the present embodiments are not limited thereto, and the electron emission sources and the protective layers can be applied to facing discharge PDPs and flat lamps which are generally used as backlight units for liquid crystal displays (LCDs).

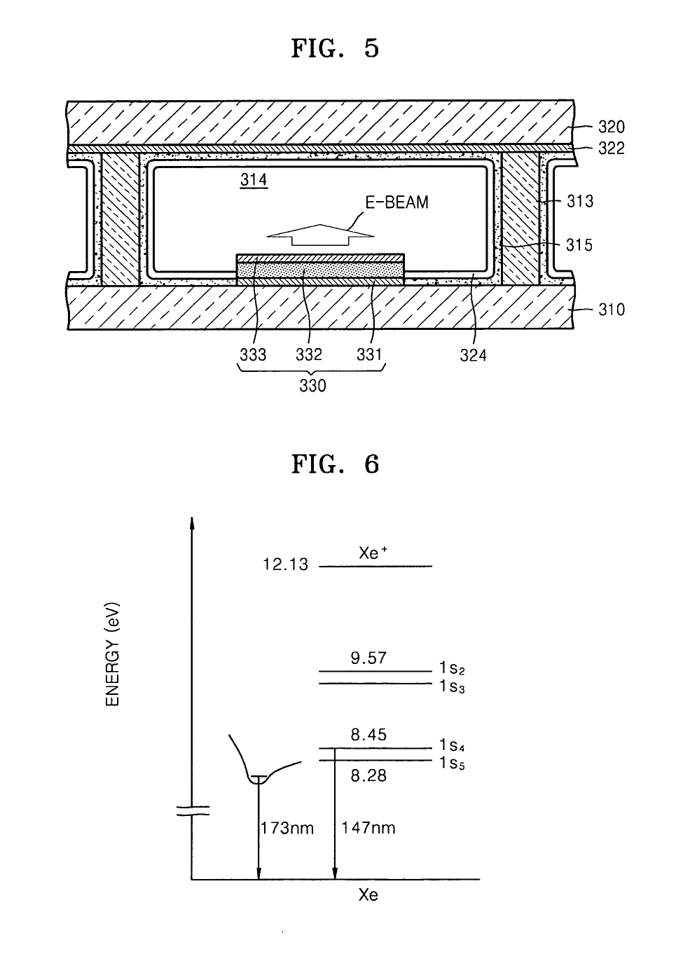

FIG. 5 is a partial sectional view of a display device according to still another embodiment.

Referring to FIG. 5, an upper substrate 320, which is a first substrate, and a lower substrate 310, which is a second substrate, face each other with a predetermined distance therebetween. In general, each of the upper substrate 320 and the second lower substrate 310 may be a glass substrate. A plurality of barrier ribs 313 are disposed between the upper substrate 320 and the lower substrate 310. The barrier ribs 313 divide a space between the upper substrate 320 and the lower substrate 310 to define a plurality of light emitting cells 314 and prevent electrical and optical cross-talk between the light emitting cells 314.

An excitation gas for generating UV rays is filled in the light emitting cells 314. Part of the excitation gas may act as a discharge gas in the present embodiment. The excitation gas may include, for example, Xe, N₂, D₂, CO₂, H₂, CO, Ne, He, or Ar.

Electron emitting means 330 for emitting electrons into the light emitting cells 314 to excite the excitation gas are formed on a top surface of the lower substrate 310. The electron emitting means 330 includes a first electrode 331 formed on the top surface of the lower substrate 310, an electron acceleration layer 332 formed on a top surface of the first electrode 331, and a second electrode 333 formed on a top surface of the electron acceleration layer 332. The electron acceleration layer 332 is formed of a material that accelerates and emits electrons into each of the light emitting cells 314. The electron acceleration layer 332 may be formed of, for example, oxidized porous silicon, CNT, DLC, or nanowire. The oxidized porous silicon can be oxidized porous polysilicon or oxidized porous amorphous silicon.

Light emitting layers 315 are respectively coated on inner walls of the light emitting cells 314, fore example, on a top surface of the lower substrate 310, a bottom surface of the upper substrate 320, and side walls of the barrier ribs 313 to a predetermined thickness. The light emitting layers 315 may be coated to a thickness of about 20 μm or less. The light emitting layers 315 are generally formed of photo-luminescent materials that generate visible light by being excited by UV rays produced from the excitation gas. The light emitting layers 315 may further include cathode-luminescent materials that generate visible light by being excited by the electrons emitted by the electron emitting means 330, or materials including quantum dots.

Protective layers 324 are formed on surfaces of the light emitting layers 315 to a predetermined thickness to prevent deterioration of the light emitting layers 315. The protective layers 324 may be coated to a thickness of about 1 μm or less. In the present embodiment, the protective layers 324 are formed of materials through which excitation sources for exciting the light emitting layers 315 can be transmitted as described above. The protective layers 324 may be formed of materials including MgF₂. The excitation sources of the light emitting layers 315 may be generally UV rays produced from the excitation gas, and may include the electrons emitted by the electron emitting means 330.

In the above structure, if predetermined voltages are applied to the first electrodes 331 and the second electrodes 333, electrons are introduced from the first electrodes 331 into the electron acceleration layers 332, accelerated by the electron acceleration layers 332, and then emitted into the light emitting cells 314 through the second electrodes 333. When voltages V₁ and V₂ are respectively applied to the first electrodes 331 and the second electrodes 333, V₁<V₂ may be satisfied. The electrons emitted into the light emitting cells 314 excite the excitation gas, and the excitation gas generates UV rays when stabilizing. The UV rays excite the light emitting layers 315 to generate visible light, and the visible light is emitted through the upper substrate 320 to form an image.

The electrons emitted into the light emitting cells 314 by the electron emitting means 330 may have energy greater than energy required to excite the excitation gas and less than energy required to ionize the excitation gas. Accordingly, voltages are applied to the first electrode 331 and the second electrode 333 so that the electrons emitted into the light emitting cells 314 by the electron emitting means 330 can have optimized electron energy high enough to excite the excitation gas.

FIG. 6 is a graph illustrating energy levels of Xe which is one example of a source for generating UV rays. Referring to FIG. 6, an energy of 12.13 eV is required to ionize the Xe, and an energy of 8.28 eV or more is required to excite the Xe. 8.28 eV, 8.45 eV, and 9.57 eV are required to excite the Xe to states 1S₅, 1S₄, and 1S₂, respectively. The excited xenon Xe* generates UV rays of about 147 nm as it stabilizes. When the excited Xenon Xe* collides with the Xe in a ground state, eximer Xenon Xe₂* is generated. The eximer Xenon Xe₂* generates UV rays of about 173 nm while stabilizing. Accordingly, when the Xe is used as the UV ray generating source in the present embodiment, the electrons emitted into the light emitting cells 314 by the electron emitting means 330 may have an energy of about 8.28 to about 12.13 eV to excite the Xe.

A plurality of third electrodes 322 may be formed on the bottom surface of the upper substrate 320 to intersect the electron emitting means 330. In this case, the light emitting layers 315 are coated on the bottom surface of the upper substrate 320 to cover surfaces of the third electrodes 322, and the protective layers 324 cover the light emitting layers 315. When voltages applied to the first electrodes 331, the second electrodes 333, and the third electrodes 322 are respectively V₁, V₂, and V₃, V₁<V₂<V₃ may be satisfied. In this case, accelerated electrons are emitted into the light emitting cells 314 by the electron acceleration layers 332 due to the voltages V₁ and V₂ applied to the first electrodes 331 and the second electrodes 333, and then accelerated toward the third electrodes 322 due to the voltages V₂ and V₃ applied to the second electrodes 333 and the third electrodes 322, thereby exciting the excitation gas. Part of the excitation gas can be controlled to a discharge state by adjusting the voltage V₃ applied to the third electrodes 322. When voltages applied to the first electrodes 331, the second electrodes 333, and the third electrodes 322 are respectively V₁, V₂, and V₃, V₁<V₂=V₃ may be satisfied.

As described above, since the electron emitting means 330 emit electrons having energy greater than that required to excite the excitation gas and less than that required to ionize the excitation gas, the display device of the present embodiment can operate at a lower a driving voltage than a conventional PDP, and can improve luminous efficiency.

Also, since the conventional PDP requires a protective layer formed of a material with a high secondary electron emission coefficient and a high resistance against ion bombardment, the protective layer was formed of magnesium oxide (MgO) through which excitation sources of light emitting layers cannot be transmitted. However, since the display device according to the present embodiment can operate at a lower a driving voltage, due to the electron emitting means 330 that can excite the excitation gas, than the conventional PDP, the protective layers 124 can be formed of materials through which the excitation sources of the light emitting layers 315 can be transmitted. Accordingly, the area of the coated light emitting layers 315 can be increased, thereby further improving brightness and luminous efficiency.

The electron emitting means 330 are disposed on the lower substrate 310 in the present embodiment, but the present embodiments are not limited thereto. Accordingly, the electron emitting means 330 may be disposed on the upper substrate 320 or on both the upper substrate 320 and the lower substrate 310. The electron emitting means 330 can also be applied to flat lamps which are generally used as backlight units for LCDs.

As described above, the display device according to the present embodiments has the following advantages.

First, since the electron emission sources uniformly emit accelerated electrons into the discharge cells, electron emission characteristics can be improved, a driving voltage of the display device can be reduced, and brightness and luminous efficiency can be improved.

Second, since the electron emitting means emit electrons having energy greater than that required to excite the excitation gas and less than that required to ionize the excitation gas, the display device can operate at a lower driving voltage than the conventional PDP, and brightness and luminous efficiency can be improved.

Third, since the protective layers formed of materials through which the excitation sources of the light emitting layers can be transmitted are formed on the surfaces of the light emitting layers, the area of the coated light emitting layers can be increased, and brightness and luminous efficiency can be further improved.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A display device comprising:
a first substrate and a second substrate facing each other with a plurality of discharge cells therebetween;
a plurality of first electrodes formed on an inner surface of the first substrate;
a plurality of electron emission sources disposed on the inner side of the first substrate corresponding to the first electrodes, configured to emit electrons into the discharge cells;
a discharge gas filled in the discharge cells;
light emitting layers formed on inner walls of the discharge cells; and
protective layers covering the light emitting layers, wherein the protective layers are formed of materials through which excitation sources that excite the light emitting layers can be transmitted.

2. The display device of claim 1, wherein the protective layers are formed of materials including magnesium fluoride (MgF₂).

3. The display device of claim 1, wherein the electron emission sources are parallel to the first electrodes.

4. The display device of claim 1, wherein the electron emission sources are formed of one selected from the group consisting of oxidized porous silicon, carbon nanotube (CNT), diamond like carbon (DLC), and nanowire.

5. The display device of claim 4, wherein the oxidized porous silicon is oxidized porous polysilicon or oxidized porous amorphous silicon.

6. The display device of claim 1, further comprising a first dielectric layer formed between the first substrate and the electron emission sources to cover the first electrodes.

7. The display device of claim 6, wherein the light emitting layers are formed on the first dielectric layer and the protective layers cover the light emitting layers.

8. The display device of claim 7, further comprising base electrodes formed between the first dielectric layer and the electron emission sources.

9. The display device of claim 1, further comprising a plurality of second electrodes formed on an inner surface of the second substrate.

10. The display device of claim 9, further comprising a second dielectric layer formed on the inner surface of the second substrate configured to cover the second electrodes,
wherein the light emitting layers are formed on the second dielectric layer, and the protective layers cover the light emitting layers.

11. The display device of claim 9, wherein the first electrodes include pairs of sustain electrodes arranged in parallel, and the second electrodes include address electrodes intersecting the sustain electrodes.

12. A display device comprising:
a first substrate and a second substrate facing each other with a plurality of discharge cells therebetween;
a plurality of first electrodes formed on an inner surface of the first substrate;
a first dielectric layer formed on the inner surface of the first substrate configured to expose surfaces of the first electrodes;
a plurality of electron emission sources disposed on the exposed surfaces of the first electrodes and configured to emit electrons into the discharge cells;
a discharge gas filled in the discharge cells;
light emitting layers formed on inner walls of the discharge cells; and
protective layers covering the light emitting layers, wherein the protective layers are formed of materials through which excitation sources that excite the light emitting layers can be transmitted.

13. The display device of claim 12, wherein the protective layers are formed of materials including MgF2.

14. The display device of claim 12, wherein the electron emission sources are formed of one selected from the group consisting of oxidized porous silicon, CNT, DLC, and nanowire.

15. The display device of claim 14, wherein the oxidized porous silicon is oxidized porous polysilicon or oxidized porous amorphous silicon.

16. The display device of claim 12, wherein the light emitting layers are formed on the first dielectric layer, and the protective layers cover the light emitting layers.

17. The display device of claim 12, further comprising a plurality of second electrodes formed on an inner surface of the second substrate.

18. The display device of claim 17, further comprising a second dielectric layer formed on the inner surface of the second substrate configured to cover the second electrodes,
wherein the light emitting layers are formed on the second dielectric layer, and the protective layers cover the light emitting layers.

19. The display device of claim 17, wherein the first electrodes include pairs of sustain electrodes arranged in parallel, and the second electrodes include address electrodes intersecting the sustain electrodes.

20. A display device comprising:
a first substrate and a second substrate facing each other with a plurality of light emitting cells therebetween;
an excitation gas filled in the light emitting cells;
light emitting layers formed on inner walls of the light emitting cells;
a plurality of electron emitting means disposed on an inner side of at least one of the first substrate and the second substrate, configured to emit electrons for exciting the excitation gas into the light emitting cells; and
protective layers covering the light emitting layers, and formed of materials through which excitation sources that excite the light emitting layers can be transmitted.

21. The display device of claim 20, wherein the protective layers are formed of materials including magnesium fluoride (MgF₂).

22. The display device of claim 20, wherein the electrons emitted by the electron emitting means have more energy than the energy required to excite the excitation gas and less energy than the energy required to ionize the excitation gas.

23. The display device of claim 20, wherein each of the electron emitting means comprises:
a first electrode formed on the inner surface of the at least one substrate;
a second electrode spaced apart from the first electrode with their surfaces facing each other; and
an electron acceleration layer disposed between the first electrode and the second electrode, configured to accelerate and emit electrons into each of the light emitting cells when voltages are applied to the first electrode and the second electrode.

24. The display device of claim 23, wherein the electron acceleration layer is formed of one selected from the group consisting of oxidized porous silicon, CNT, DLC, and nanowire.

25. The display device of claim 24, wherein the oxidized porous silicon is oxidized porous polysilicon or oxidized porous amorphous silicon.

26. The display device of claim 23, further comprising third electrodes formed on an inner side of the remaining one of the first substrate and the second substrate where the electron emitting means are not disposed.

27. The display device of claim 26, wherein, when voltages respectively applied to the first electrodes, the second electrodes, and the third electrodes are V₁, V₂, and V₃, and wherein V₁<V₂<V₃.

28. The display device of claim 26, wherein, when voltages respectively applied to the first electrodes, the second electrodes, and the third electrodes are V₁, V₂, and V₃, and wherein V₁<V₂, V₁<V₃ and V₂ is substantially equal to V₃.
